(19) United States
(12) Patent Application Publication
(10) Pub. No.: US 2005/0020120 A1
(43) Pub. Date: Jan. 27, 2005

(54) Removing fixture used in connector

(76) Inventor: Zhen-Rong Chen, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/898,402

(22) Filed: Jul. 23, 2004

(30) Foreign Application Priority Data
Jul. 23, 2003 (TW) 92213444

(51) Int. Cl. H01R 13/625

(52) U.S. Cl. 439/342

(57) ABSTRACT

A removing fixture (20) is provided for easily and readily removing a bushing (12) from an electrical connector (10) mounted on a PCB. The connector has two protrusions (1000), each protrusion defining a receiving hole (1002) therein. The bushing including a through hole (120) therein and latches (122) formed thereon and hooking a bottom of the protrusion for firmly retaining the bushing in the protrusion. The removing fixture includes a supporting member (22) having a pressing wall (224) and a pulling rod (24) capable of being inserted into the through hole of the bushing. The pulling rod has a longitudinal lever (242) and a larger action portion (244) extending from a bottom end of the lever. During removing the bushing, the pressing wall of the supporting body urges against the latches of the bushing to unhook the bushing from the protrusion easily. Then the pulling rod is driven to insert into the through hole of the bushing and hold a bottom of the bushing on the action portion. The pulling rod is driven to move upwardly away from the connector, applying a pressing force at the bottom of the bushing by the action portion. Thus, the bushing is moved with the pulling rod and withdrawn from the hole of the protrusion easily and readily.

### BACKGROUND OF THE INVENTION

1. Field of the Invention

The present invention relates to electrical connectors, and more particularly to a removing fixture used in an electrical connector for removing a bushing from the connector.

2. Description of the Prior Art

Electrical connectors are widely used for electrically connecting electronic packages such as integrated circuits (ICs) with substrate circuits such as bum-in boards. Generally, a typical connector comprises an insulative housing mounted on a printed circuit board (PCB). The housing has two protrusions extending outwardly from two diagonal comers thereof. Each protrusion defines a hole therethrough and a determined space between the PCB. A metal bushing with latches is received in the hole of the protrusion. The latches of the bushing hook a bottom of the protrusion through the hole, for firmly retaining the bushing in the hole.

An IC is mounted to the housing and pressed down to reliably electrically connect with the connector by a pressing plate attached to the connector. Guiding poles are formed on the pressing plate, engaging with the bushing, for fixing the IC on the connector. After having been used repeatedly many times, the bushing may be damaged because of a friction of the guiding pole of the pressing plate. The bushing damaged should be removed from the connector and be replaced by a new one. Because the connector is mounted on the PCB and the bushing hooks the protrusion, it is difficult to remove the bushing out of the hole of the protrusion.

A convention method of removing the bushing from the connector is to wipe off the latches of the bushing. This thereby damages the hook between the bushing and the protrusion. Then the bushing is withdrawn out of the hole of the protrusion. However, it is hard to reset the latches of the bushing, because of a limitation of the space between the protrusion and the PCB. In addition, the bushing is firmly retained in the hole of the protrusion. This makes it hard to apply a force to the bushing. As a result, the bushing cannot be move away from the hole of the protrusion easily and readily.

In view of the above, a new removing fixture that overcomes the above-mentioned disadvantages is desired.

### SUMMARY OF THE INVENTION

An object of the present invention is to provide a removing fixture used in a connector, whereby the removing fixture is configured to withdraw a bushing from the connector easily and readily.

To fulfill the above object, a removing fixture used in a connector in accordance with a preferred embodiment of the present invention is provided. The connector comprises an insulative housing having two diagonal protrusions. Each protrusion defines a receiving hole therein. A bushing is retained in the receiving hole, hooking a bottom of the protrusion. The removing fixture is used for withdrawing the bushing from the connector and comprises a supporting member and a pulling rod. The supporting member has a main body and a pressing wall extending from a bottom end of the body. The pulling rod comprises a longitudinal lever and an action portion extending from an end of the lever. During removing the bushing, the pressing wall of the supporting member urges against the bushing to unhook the bushing from the protrusion. Then the pulling rod is inserted through the bushing, abutting against a bottom of the bushing by the action portion. A radial dimension of the action portion is larger than a radial dimension of the lever. This enables the pulling rod to hook the bottom of the bushing. The pulling rod is pulled upwardly away from the connector, applying an urging force at the bottom of the bushing by the action portion. Thus the bushing is drawn out of the receiving hole of the protrusion easily and readily.

Other objects, feature novels and advantages of the invention will become more apparent from the following detailed description when taken in conjunction with the accompanying drawings, in which:

### BRIEF DESCRIPTION OF THE DRAWINGS

FIG. 1 is an exploded, isometric view of a connector in accordance with a preferred embodiment of the present invention;

FIG. 2 is an exploded, isometric view of a removing fixture of the present invention used in the connector of FIG. 1;

FIG. 3 is an isometric view of a supporting member of the removing fixture of FIG. 2, before the supporting member being assembled to the connector.

FIG. 4 is similar with FIG. 3, but viewed from an opposite aspect;

FIG. 5 is a part assembled, isometric view of the removing fixture and the connector, the supporting member having been assembled to the connector and before a pulling rod of the removing fixture being assembled to the connector;

FIG. 6 is a whole assembled, isometric view of the removing fixture of FIG. 2 and the connector of FIG. 1;

FIG. 7 is cross-sectional view taken along a line VII-VII of FIG. 6;

FIG. 8 is an assembled, isometric view of the removing fixture of FIG. 2 and the connector of FIG. 1, showing the removing fixture withdrawing the bushing from the connector; and

FIG. 9 is cross-sectional view taken along a line IX-IX of FIG. 8

### DETAILED DESCRIPTION OF THE PREFERRED EMBODIMENT OF THE INVENTION

Reference will now be made to the drawings to describe the invention in detail.

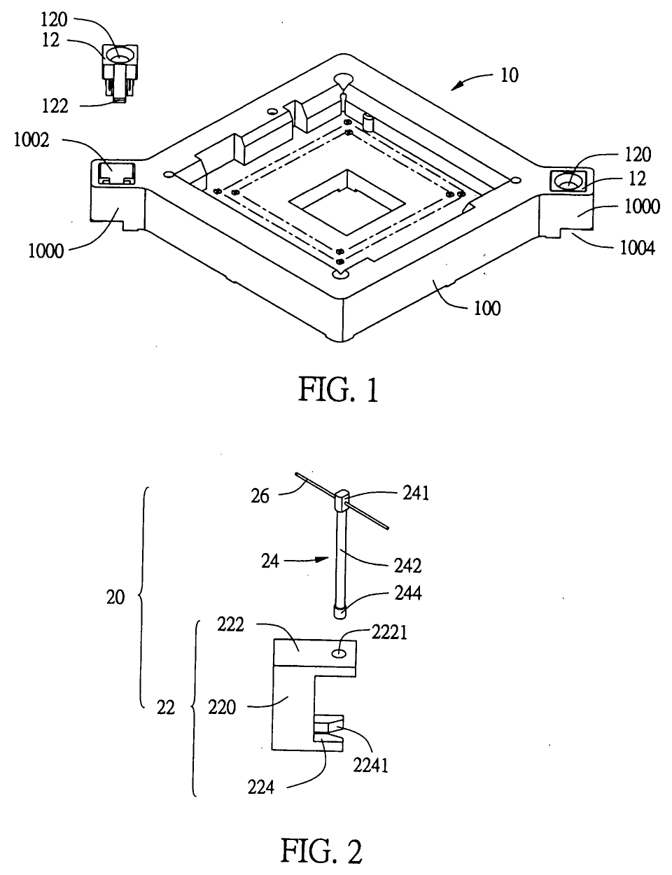

Referring to FIGS. 1 and 2, a removing fixture 20 in accordance with a preferred embodiment of the present invention is provided for removing a bushing 12 from an electrical connector 10. The connector 10 is used for electrically connecting an IC (not shown) with a test printed circuit board (PCB, not shown). The connector 10 comprises a rectangular insulative housing 100 mounted on the PCB. A pair of protrusions 1000 project outwardly from two diagonal comers of the housing 100. Each protrusion 100 defines a receiving hole 1002 therethin. A corresponding bushing 12 is retained in the receiving hole 1002. The bushing 12 defines a circular through hole 120 at a middle portion thereof. A pair of latches 122 is formed outwardly at a bottom of the bushing 12. The latches 122 hook a bottom of the protrusion 1000 through the receiving hole 1002. Thus, the bushing 12 is firmly retained in the receiving hole 1002 of the protrusion 100. A predetermined space 1004 is defined between the bottom of the protrusion 1000 and the PCB, for accommodating a part of the removing fixture 20 therein. The removing fixture 20 is used for drawing the bushing 12 out of the receiving hole 1002 of the connector 10.

Particularly referring to FIG. 2, the removing fixture 20 comprises a supporting member 22 and a pulling rod 24 capable of being inserted through the supporting member 22. In this preferred embodiment, the removing fixture 20 further comprises an operating pole 26 assembled on the pulling rod 24. The operating pole 26 can facilitate applying a force by hand to drive the pulling rod during removing the bushing 12 from the connector 10.

The supporting member 22 is configured with a vertical main body 220, a horizontal platform 222 extending forwardly from a top end of the body 220 and a pressing wall 224 extending forwardly from an opposite bottom end of the body 220. A guiding hole 2221 is defined at a front portion of the platform 222. The guiding hole 2221 extends through the platform 222, for facilitating insertion the pulling rod 24 therethrough and into the through hole 120 of the bushing 12. The pressing wall 224 comprises two parallel alignment portions separated from each other. Each portion has an inside surface and forms inwardly a chamfer 2241 at a front end thereof. The chamfers 2241 of the two portions are opposite each other. A substantial V-shaped gap (not numbered) is defined between the two portions of the pressing wall 224, for facilitating release a hook between the latches 122 and the protrusion 1000. A part of the gap is narrower than an outmost span between the latches 122 of the bushing 12. A vertical height of the pressing wall 224 is generally identical with a vertical distance of the space 1004 between the protrusion 100 and the PCB. During removing the bushing 12, the pressing wall 224 is pushed and disposed in the space 1004 between the protrusion 100 and the PCB. The latches 122 of the bushing 12 is inserted and located in the gap between the two portions. During being pushed into the space 1004, the two portions of the pressing wall 224 urges against and press the latches 122 of the bushing 12 inwardly by the inside surfaces. Thus, the latches 122 are unhooked from the protrusion 1000 of the housing 100 easily. It is noticed to say, the gap between the two portions of the pressing wall 224 is not limited to the V-shaped configuration. It also has any other compatible configuration, such as, it has a rear narrow section and a front large section communicating with the narrow section, and the narrow section is slightly narrower than the outmost span of the latches 122. As long as the latches 122 of the bushing 12 can be entered into the gap easily and pressed inwardly during the pressing wall 224 being pushed into the space 1004.

The pulling rod 24 comprises an upper operation portion 241, a lower action portion 244 with a circular profile and a longitudinal circular lever 242 interconnection with the operation portion 241 and the action portion 244. The operation portion extends coaxially upwardly from a top end of the lever 242. A radial dimension of the operation portion 241 is larger than a diameter of the action portion 244 and a diameter of the guiding hole 2221 in the top platform 222 of the supporting member 22. The action portion 244 extends coaxially downwardly from an opposite bottom end of the lever 242. The diameter of the action portion 244 is larger than a diameter of the lever 242. A shoulder surface (not numbered) is formed on the action portion 244 adjacent the lever 242. In addition, the diameter of the action portion 244 is also less than the diameter of the guiding hole 2221 of the supporting member 22 and a diameter of the through hole 120 of the bushing 12. This configuration makes the pulling rod 24 can be easily inserted into the through hole 120 of the bushing 12 by the guiding hole 2221 of the supporting member 22. Another, it also enables the action portion 244 of the pulling rod 24 to hold the bottom of the bushing 12 on the shoulder surface thereof and then apply a pressing force at the bottom of the bushing 12 during removing the bushing 12. The operating pole 26 is assembled on the operation portion 241 of the pulling rod 24, for facilitating driving the pulling rod 24 by hand during removing the bushing 12.

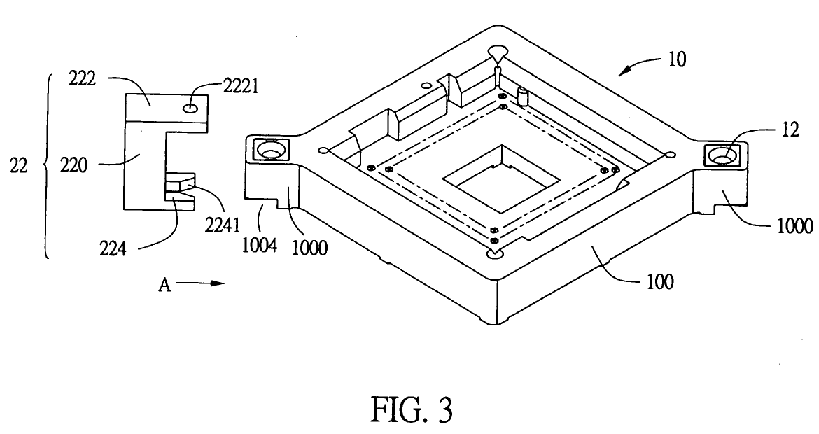

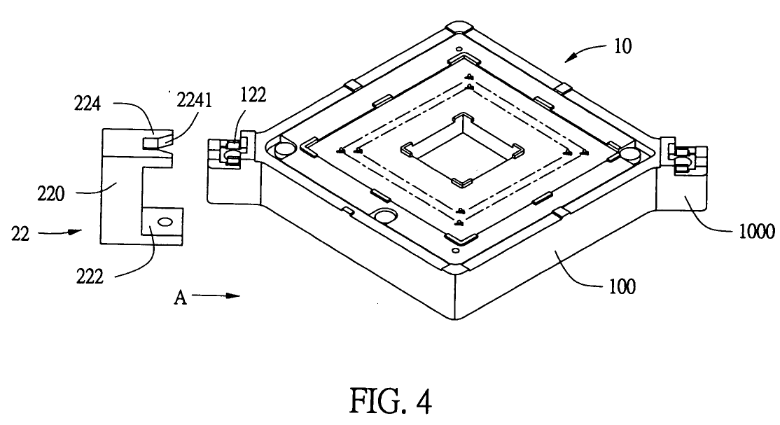

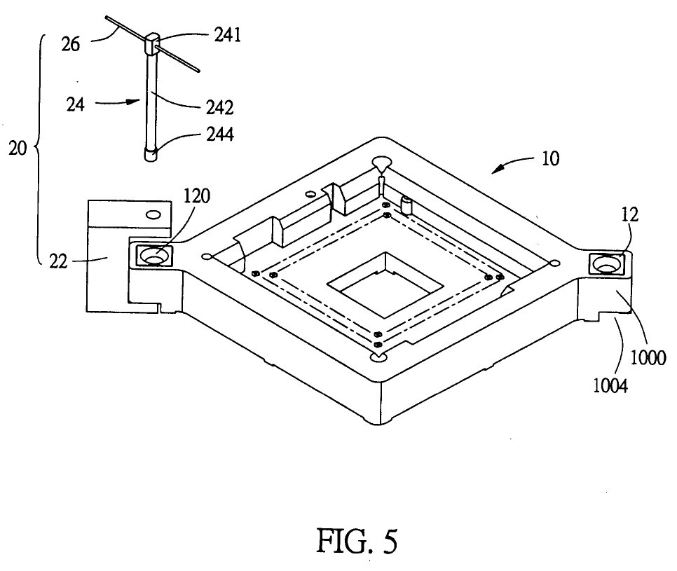

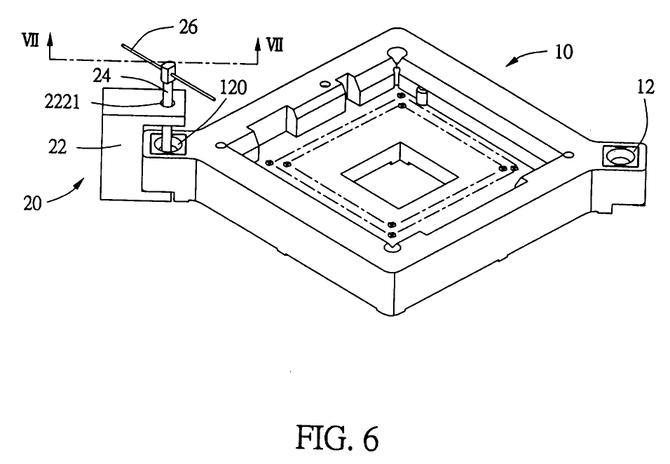

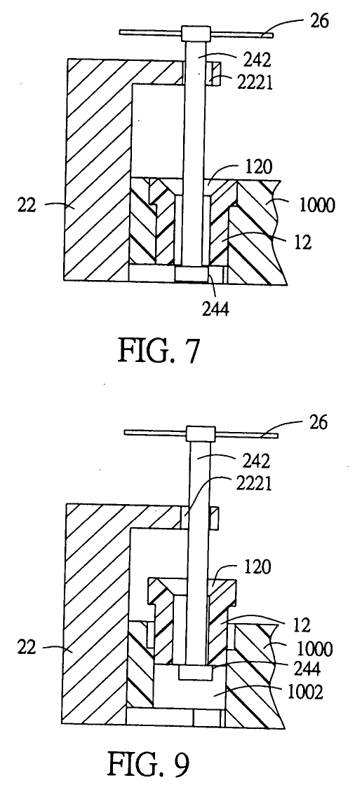

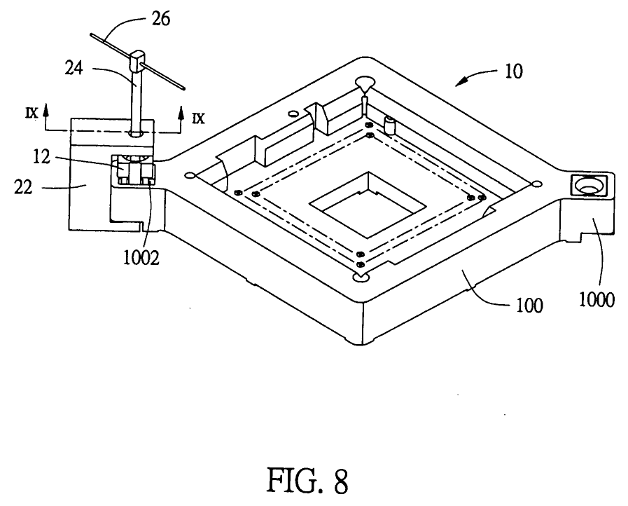

Referring to FIGS. 3 to 7, in use, the pressing wall 224 of the supporting member 22 is pushed and placed into the predetermined space 1004 between the protrusion 1000 and the PCB along direction A. The latches 122 of the bushing 12 enter and are located in the gap between the two portions of the pressing wall 224. Because a part section of the gap is narrower than the outmost span of the latches 122, the two portions of the pressing wall 224 clip the latches 122 of the bushing 12 in the gap therebetween and urge against the latches 122 inwardly during being pushed into the space 1004. This thereby can release the hook between the latches 122 and the protrusion 1000. Thus, the bushing 12 is unhooked from the housing 100 easily without wiping off and damaging the latches 122. Then the pulling rod 24 is inserted downwardly through the guiding hole 2221 of the supporting member 20 and into the through hole 120 of the bushing 12. The action portion 244 of the pulling rod 24 extends beyond a bottom of the though hole 120. The pulling rod 24 is driven to move in the through hole 120 of the bushing 12 and abut against the bottom of the bushing 12. Because the diameter of the action portion 244 is larger than the diameter of the lever 241, this thereby can make the action portion 244 holds the bottom of the bushing 12 on the shoulder surface thereof readily. And then the operating pole 26 is operated by hand to drive the pulling rod 24. The pulling rod 24 is pulled and moves upwardly away from the connector 10 by the driving of the operating pole 26. Because the action portion 244 abuts against and holds the bottom of the bushing 12, the pulling rod 24 applies an urging force at the bottom of the bushing 12 by the action portion 244 during being pulled and moving upwardly. Thus, the bushing 12 is pressed and moves upwardly with the pulling rod readily. As a result, the bushing 12 is removed out of the receiving hole 1002 of the connector 10 easily and readily.

While the present invention has been described with reference to the preferred embodiment, the description is illustrative and is not to be construed as limiting the invention. Therefore, various equivalent modifications and changes known to persons skilled in the art according to the spirit of the present invention are considered within the scope of the present invention as defined in the appended claims.

1. A removing fixture used in an electrical connector with a bushing for removing the bushing from the connector, the connector having a housing, the busing being retained the housing, wherein the bushing has a through hole defined therein and latches formed at a bottom end thereof and the latches of the bushing are adapted to hook a bottom of the housing for firmly retaining the bushing in the housing, the removing fixture comprising
a supporting member having a main body and pressing walls extending from a bottom end of the main body for unhooking the latches of the bushing from the housing easily; and
a pulling rod capable of being inserted into the through hole of the bushing, the pulling rod having a longitudinal narrow lever and a large action portion extending from a bottom end of the lever, a radial dimension of the action portion being less than a radial dimension of the through hole of the bushing, after being inserted through the through hole of the bushing, the action portion is driven to hold a bottom of the bushing.

2. The removing fixture as claimed in claim 1, wherein the pressing wall of the main body defines a gap for locating the latches therein, a part section of the gap being narrower than an outmost span of the latches of the bushing.

3. The removing fixture as claimed in claim 2, wherein the supporting member further comprises a platform extending from an opposite top end of the main body.

4. The removing fixture as claimed in claim 3, wherein the platform defines a guiding hole therein, the guiding hole extending through the platform for facilitating insertion the pulling rod therethrough and into the through hole of the bushing.

5. The removing fixture as claimed in claim 4, further comprising an operating pole assembled on the pulling rod, for facilitating to drive the pulling rod.

6. The removing fixture as claimed in claim 5, wherein the pushing rod further comprises an operation portion extending upwardly from an opposite top end of the lever, the operating rod being assembled to the operation portion.

7. A removing fixture used in an electrical connector mounted on a PCB, the connector having a housing and a corresponding bushing received in the housing, a predetermined space is defined between the PCB and the housing where the bushing being retained, wherein the bushing having a through hole therein and latches formed at a bottom end thereof, the latches of the bushing hooking a bottom of the protrusion for firmly retaining the bushing in the protrusion, the removing fixture is for withdrawing the bushing out of housing easily, comprising
a supporting member having a vertical main body and a pressing wall extending horizontal and forwardly from a bottom end of the body, a vertical height of the pressing wall being generally identical with a vertical distance of the space between housing and the PCB, the pressing wall being pushed and disposed into the space for releasing a hook between the latches of the bushing from and the housing easily during removing the bushing; and
a pulling rod capable of being inserted into the through hole of the bushing, the pulling rod having a longitudinal lever and an action portion extending coaxially from a bottom end of the lever, a radial dimension of the action portion being larger than a radial dimension of the lever and less than a radial dimension of the through hole of the bushing, a shoulder surface is formed on the action portion adjacent the lever, after being inserted through the through hole of the bushing, the action portion is actuated to hold a bottom of the bushing on the shoulder surface thereof and apply a pressing force at the bottom of the bushing during removing the bushing.

8. The removing fixture as claimed in claim 8, wherein the pressing wall of the body comprises two portions separated from each other to form a gap therebetween, the gap having a rear narrow section and a front large section communicating with the large section, an outmost span of the latches of the bushing being larger than the narrow section and less than the large section of the gap.

9. The removing fixture as claimed in claim 8, wherein the supporting member further comprises a horizontal platform extending from an opposite top end of the body, a guiding hole is defined through the platform, having a large radial dimension than the action portion of the pulling rod for facilitating the insertion of the pulling rod into the bushing.

10. The removing fixture as claimed in claim 9, further comprising an operating pole assembled on the pulling rod for facilitating to drive the pulling rod.

11. In combination,
an electrical connector adapted to be mounted to a printed circuit board;
a projecting ear formed on one side of the connector with a space under said projecting ear;
a receiving hole defined in the projecting ear;
a bushing releasably disposed in the receiving hole;
a through hole defined and surrounded by a tubular body of the bushing; and
a pulling rod having an enlarged action portion at a bottom end of a longitudinal bar; wherein
said through hole is dimensioned to be large enough to not only allow the enlarged action portion to extend therethrough and reach the space, but also allow the longitudinal bar laterally moved therein so as to have the enlarged action portion upward confront the tubular body rather than the through hole of the bushing; whereby
upon upwardly moving the pulling rod, the bushing is withdrawn from the receiving hole.

12. The combination as claimed in claim 11, further including a supporting member with a lower portion disposed in the space and an upper portion located above the projecting ear and defining an opening through which the longitudinal bar moveably extends.
